(19) United States
(12) Patent Application Publication
(10) Pub. No.: US 2024/0265369 A1
(43) Pub. Date: Aug. 8, 2024

(54) CHECKOUT APPARATUS AND CHECKOUT METHOD

(71) Applicant: Toshiba Tec Kabushiki Kaisha, Tokyo (JP)

(72) Inventors: Norimasa ARIGA, Izunokuni Shizuoka (JP); Kenichi KOMIYA, Kawasaki Kanagawa (JP); Kazuhiko OHTSU, Mishima Shizuoka (JP); Seiya SHIMIZU, Numazu Shizuoka (JP)

(21) Appl. No.: 18/409,429

(22) Filed: Jan. 10, 2024

(30) Foreign Application Priority Data
Feb. 8, 2023 (JP) 2023-017503

(51) Int. Cl. G06Q 20/22; G06V 30/18; G06V 40/16

(52) U.S. Cl. CPC G06Q 20/227; G06V 30/18; G06V 40/16

(57) ABSTRACT

According to an embodiment, a checkout apparatus includes a communication interface connectable to a network, a display unit positioned to face a customer at the checkout apparatus, an input unit configured to receive user inputs from the customer, and a control unit. The control unit is configured to acquire transaction information for a transaction of the customer via the communication interface, receive customer identifying information identifying the customer, acquire payment method information indicating a payment method associated with the customer identifying information, and execute payment processing for the transaction based on the acquired transaction information using the payment method associated with the customer.

### CROSS-REFERENCE TO RELATED APPLICATION

This application is based upon and claims the benefit of priority from Japanese Patent Application No. 2023-017503, filed Feb. 8, 2023, the entire contents of which are incorporated herein by reference.

### FIELD

Embodiments described herein relate generally to a checkout apparatus and a checkout method for retail stores and the like.

### BACKGROUND

In recent years, as various types of cashless payments have become popular, the payment methods used by customers at retail stores, restaurants, and the like which sell merchandise and services (hereinafter, collectively referred to as “merchandise”) have diversified. Therefore, a checkout apparatus which permits a payment method to be selected from the many possible payment methods has been developed.

Such a checkout apparatus may require hierarchical menu operation depending on the payment method selected by the customer. For example, if credit-card payment is initially selected, the operator of the checkout apparatus may need to perform additional operations to select among still available options or to provide additional information after selecting the credit-card payment. In other examples, if a code payment method (such as a QR code-based payment method) is selected, the operator may need to perform additional operations to select a type of code payment after selecting the initial code payment option. Therefore, selecting a payment method at the checkout apparatus becomes more complicated for an operator.

A related art apparatus provides a checkout apparatus which automatically carries out a payment processing for a customer based on credit-card information associated in advance with customer identifying information input to the checkout apparatus. This type checkout apparatus is easy to operate since the checkout apparatus does not require any selection of a payment method. However, the payment method is thus limited to a credit-card payment, and such a checkout apparatus does not provide user freedom to select the payment method.

### BRIEF DESCRIPTION OF THE DRAWINGS

FIG. 1 is a diagram illustrating a configuration of a checkout system according to an embodiment.

FIG. 2 is a block diagram of a store server.

FIG. 3 is a diagram illustrating a data configuration of a customer information file.

FIG. 4 is a diagram illustrating a data configuration of a transaction information file.

FIG. 5 is a block diagram of a controller for a store server.

FIG. 6 is a block diagram of a checkout apparatus.

FIG. 7 is a block diagram of a controller for a checkout apparatus.

FIG. 8 is a flowchart of a checkout processing.

FIG. 9 is a diagram illustrating a first screen displayed by a display unit.

FIG. 10 is a diagram illustrating a second screen displayed by a display unit.

FIG. 11 is a diagram illustrating a third screen displayed by a display unit.

FIG. 12 is a flowchart of an ordinary-payment processing.

FIG. 13 is a flowchart of a shortened-payment processing.

FIG. 14 is a diagram illustrating a fourth screen displayed by a display unit.

FIG. 15 is a diagram illustrating a membership card.

FIG. 16 is a flowchart of a checkout processing.

### DETAILED DESCRIPTION

At least one embodiment described herein provides an improved checkout apparatus and checkout method providing technological solutions to existing issues in the related art for improving ease of operator use of a checkout apparatus while securing freedom for a customer to select a payment method.

According to an embodiment, a checkout apparatus includes a communication interface connectable to a network, a display unit positioned to face a customer at the checkout apparatus, an input unit configured to receive user inputs from the customer, and a control unit. The control unit is configured to acquire transaction information for a transaction of the customer via the communication interface, receive customer identifying information identifying the customer, acquire payment method information indicating a payment method associated with the customer identifying information, and execute payment processing for the transaction based on the acquired transaction information using the payment method associated with the customer.

A checkout apparatus and a checkout method according to certain, non-limiting example embodiments are described. The of the example embodiments describe a checkout apparatus a semi-self-service POS (Point Of Sales) checkout apparatus or system including a registration apparatus operated by a store clerk to perform operations related to merchandise registration and a checkout apparatus operated by a customer to perform operations related to payment for the registered merchandise. In other examples, the checkout apparatus may be a self-service POS terminal operated by a customer to perform the operations related to the merchandise registration and the payment.

In still other examples, the checkout apparatus may be a POS terminal operated by a store clerk to perform the operations related to the merchandise registration and payment. Furthermore, the checkout apparatus may be a checkout apparatus used in systems such as a “cart POS” system or a “smartphone POS” system. Here, a cart POS system is a system in which, for example, a customer registers merchandise by himself or herself using a tablet terminal mounted on a shopping cart, and the customer then pays for the registered merchandise by operating a checkout apparatus which acquires transaction information based on the merchandise registration made using the cart mounted terminal. A smartphone POS system is a system in which a smartphone owned by a customer (or provided by the store) is used similarly to the cart mounted tablet terminal in order to register merchandise. The specific example embodiments described below may be considered especially beneficial to a checkout-related apparatus which is operated by the customer himself or herself, such as the checkout apparatus in a semi-self-service POS system, a self-service POS terminal, a cart POS checkout apparatus, and a smartphone POS checkout apparatus.

### Embodiment 1

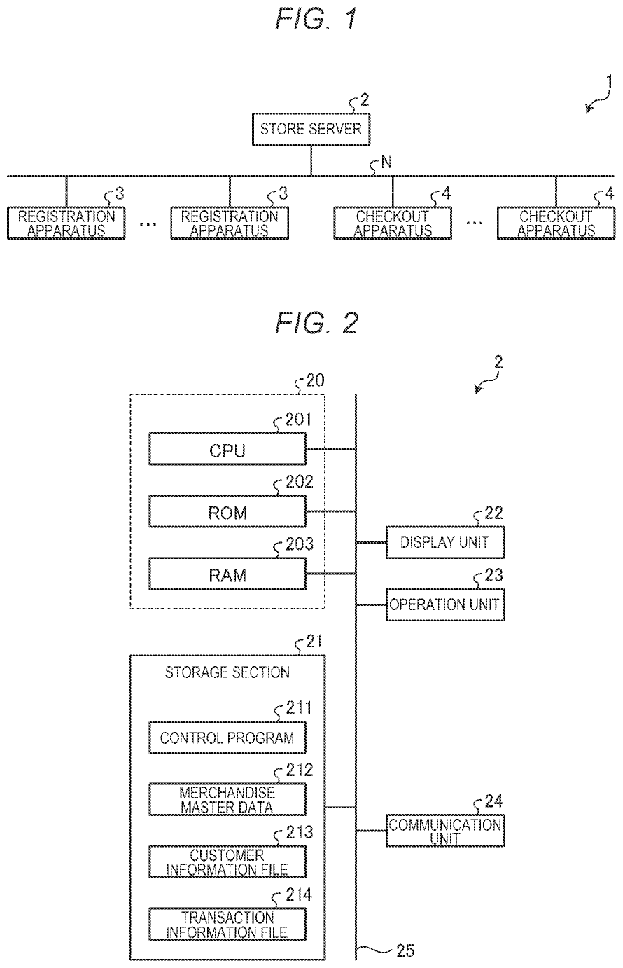

A checkout apparatus and a checkout method according to Embodiment 1 are described with reference to the drawings. FIG. 1 is a diagram illustrating a configuration of a checkout system 1. The checkout system 1 is used at a store (e.g., a supermarket) which sells merchandise. The checkout system 1 includes a store server 2, a plurality of registration apparatuses 3, and a plurality of checkout apparatuses 4.

The store server 2, the registration apparatuses 3, and the checkout apparatuses 4 are communicably connected to each other via a network N. The network N is, for example, a wired or wireless LAN (Local Area Network). Note that the number of registration apparatuses 3 and the number of checkout apparatuses 4 are not limited to the illustrated example.

When a customer brings merchandise to be purchased to the registration apparatus 3, the store clerk uses the registration apparatus to read or enter a merchandise code of the to-be-purchased merchandise For example, the registration apparatus 3 uses a product scanner to read the merchandise code from a code symbol attached to or associated with the merchandise. The merchandise code is information which identifies the merchandise. The registration apparatus 3 transmits, to the store server 2, the read merchandise code together with registration apparatus identifying information. The registration apparatus identifying information is information which particularly identifies the registration apparatus 3 being used, and is a registration apparatus number, for example.

When the store server 2 receives, from one registration apparatus 3, the first merchandise code in a transaction, the store server 2 issues a transaction ID. The store server 2 carries out merchandise registration based on the received merchandise codes. Here, merchandise registration refers to the processing to register (store) merchandise information (e.g., the merchandise code, a merchandise name, and a price) in association with the issued transaction ID. When the store server 2 completes the merchandise registration of a merchandise item, the store server 2 transmits the merchandise information and the transaction ID to the registration apparatus 3. After this, the store server 2 carries out the merchandise registration every time the store server 2 receives another merchandise code from the registration apparatus 3.

When the merchandise registration regarding all the to-be-purchased merchandise items for a customer is completed, the registration apparatus 3 transmits a forwarding instruction to the store server 2. The forwarding instruction is an instruction to forward transaction information to a checkout apparatus 4, and the forwarding instruction includes the transaction ID and the checkout apparatus number for the checkout apparatus 4 to which the information is forwarded. The transaction information is data including the merchandise information of the registered merchandise in the transaction (i.e., the data including all the merchandise information associated with one transaction ID). When the store server 2 receives the forwarding instruction, the store server 2 extracts the transaction information for the transaction ID included in the forwarding instruction, and transmits the extracted transaction information to a specified checkout apparatus 4.

The customer moves to the checkout apparatus 4 where the transaction information is forwarded. The checkout apparatus 4 carries out checkout processing based on operations by the customer. The checkout processing is processing by which a customer pays for a purchase of merchandise, and includes payment processing. During the checkout processing, the checkout apparatus 4 may receive input of customer identifying information which uniquely identifies the customer. The customer identifying information is, for example, feature data of a facial image of the customer for image recognition or the like.

The checkout apparatus 4 acquires, from the store server 2, payment method information corresponding to the inputted customer identifying information. The payment method information is information associated with the customer identifying information in advance and indicates a payment method (e.g., a customer preferred payment method). The payment method is, for example, cash payment (payment by cash), credit-card payment (payment by a credit card), or code payment (payment by a two-dimensional code reading or the like). Note that the payment methods also include electronic money payment (payment by electronic money service), points payment (payment by accumulated points such as customer loyalty program points), or other payment options.

The checkout apparatus 4 can carry out the payment processing using the payment method indicated by the payment method information acquired from the store server 2. Therefore, the checkout apparatus 4 is capable of simplifying operation for the customer by preselecting or designating a payment method. The customer is not required to perform any troublesome operations, such as navigating a menu of options for selecting the payment method, selecting/inputting a particular credit-card payment type from a credit-card payment sub-menu, or selecting a particular payment type from a code payment sub-menu. Note that in the following description the payment method indicated by the payment method information acquired from the store server 2 may be referred to as a “payment method acquired from the store server 2,” a “customer preferred payment method,” a “pre-designated payment method,” or the like.

Next, each apparatus included in the checkout system 1 is described. First, the store server 2 is described. The store server 2 manages various information of the store. FIG. 2 is a block diagram illustrating a substantial hardware configuration of the store server 2.

The store server 2 includes a controller 20, a storage section 21, a display unit 22, an operation unit 23, and a communication unit 24. The controller 20, the storage section 21, the display unit 22, the operation unit 23, and the communication unit 24 are connected to each other via a bus 25 and the like. Note that the store server 2 may comprise a plurality of computers or may be provided with an external memory storage.

The controller 20 includes a CPU (Central Processing Unit) 201, a ROM (Read Only Memory) 202, and a RAM (Random Access Memory) 203. The CPU 201, the ROM 202, and the RAM 203 are connected to each other via the bus 25.

The CPU 201 controls the entire operation of the store server 2. The ROM 202 stores various programs (e.g., a program used for activation/startup of the CPU 201) and various data. The RAM 203 is used as a work area of the CPU 201, and loads various programs and various data stored in the ROM 202 and the storage section 21. The controller 20 executes various control processing by the CPU 201 operating in accordance with a control program stored in the ROM 202 and/or the storage section 21 and loaded into the RAM 203 for execution.

The storage section 21 includes a storage medium such as an HDD (Hard Disk Drive) and a flash memory, and retains the stored content even after power is removed. The storage section 21 stores a control program 211, merchandise master data 212, a customer information file 213, and a transaction information file 214.

The control program 211 is, for example, a program to implement functions to execute the merchandise registration, functions to receive the customer identifying information from the checkout apparatus 4, and functions to extract the payment method information corresponding to the received customer identifying information and transmit the extracted payment method information to the checkout apparatus 4.

The merchandise master data 212 is a master file which stores merchandise information on merchandise available at the store. The merchandise master data 212 stores a merchandise name, a price, a tax amount and the like so as to be associated with the merchandise code. Note that the merchandise available at the store varies on a daily basis, and thus, the merchandise master data 212 is suitably updated.

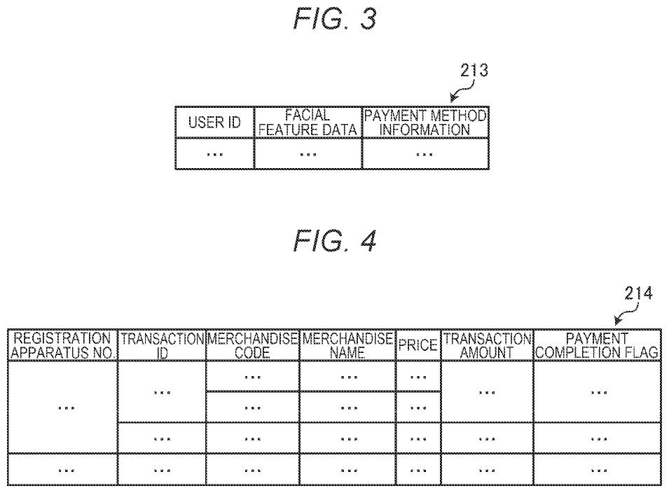

The customer information file 213 is a file which manages the payment method on a per customer basis. The information to be stored in the customer information file 213 is registered upon request from the customer. For example, the information to be stored in the customer information file 213 is registered based on operation of the checkout apparatus 4 by the customer or operation of the operation unit 23 by the store clerk for the customer. FIG. 3 is a diagram illustrating a data configuration of the customer information file 213. The customer information file 213 stores a user ID, facial feature data, and payment method information in association with each other.

The user ID is information assigned on a per user basis, such as a membership number at the store, for example. The user ID may be issued when the facial feature data and the payment method information are registered in the customer information file 213. The facial feature data is feature data extracted from a facial image of the customer. The facial feature data is information that can be used for customer recognition using a known facial recognition technique or the like. The user ID and the facial feature data are information which can identify the customer and each is an example of the customer identifying information. Note that the customer identifying information may be other information which can identify the customer such as biometric data other than facial feature data.

The payment method information is information indicating a preferred payment method (e.g., cash payment, credit-card payment, and code payment). Note that if the payment method information indicates credit-card payment, the payment method information may further include information such as a name of the credit-card company, a credit card number, payment installments, etc. If the payment method information indicates code payment, the payment method information further includes information such as a name of a settlement management company, the type of code payment, etc. That is, the stored payment method information can include all the information necessary for the making (completing) of the payment by the payment method.

The transaction information file 214 is a file which manages the transaction information. The transaction information file 214 is updated based on information acquired from the registration apparatus 3 and the checkout apparatus 4. FIG. 4 is a diagram illustrating a data configuration of the transaction information file 214. The transaction information file 214 stores the registration apparatus number, the transaction ID, the merchandise code, the merchandise name, the price, a transaction amount, and a payment completion flag in association with each other.

The registration apparatus number is a number to identify the registration apparatus 3. The transaction ID is information to identify the transaction. The merchandise code is information to identify the merchandise being purchased. The merchandise name is information indicating the name of the merchandise. The price is information indicating a unit price of the merchandise. When a plurality of merchandise items are purchased in one transaction, a plurality of merchandise codes, merchandise names, and prices are registered in association with the transaction ID.

The transaction amount is information indicating the total amount of merchandise prices in one transaction. The payment completion flag is information indicating whether the payment related to the transaction is completed, in other words, whether the checkout processing by the checkout apparatus 4 has been completed. When the payment for transaction is completed, the payment completion flag is registered to be “1”, whereas when the payment is not completed, the payment completion flag is registered to be “0”. The payment completion flag is rewritten to be “1” in response to receipt of a payment completion notification from the checkout apparatus 4. The payment completion notification indicates the completion of the payment concerning the transaction, and includes information for the transaction ID of a transaction for which the payment has been completed.

Returning back to FIG. 2, hardware of the store server 2 is described. The display unit 22 includes, for example, a liquid crystal panel, and displays various information. For example, the display unit 22 displays a registration screen to register the merchandise information to the merchandise master data 212, a registration screen to register information to the customer information file 213, and the like.

The operation unit 23 is operated to input information into the controller 20, and includes a keyboard, a touch panel provided to a surface of the display unit 22, and/or the like. For example, the operation unit 23 is operated to input, into the controller 20, the merchandise information to be registered to the merchandise master data 212, and the information to be registered to the customer information file 213.

The communication unit 24 is an interface to communicate with an external apparatus such as the registration apparatus 3 and the checkout apparatus 4. The controller 20 is connected to the external apparatus via the communication unit 24, and therefore, the controller 20 can transmit and receive information (data) to and from the external apparatus.

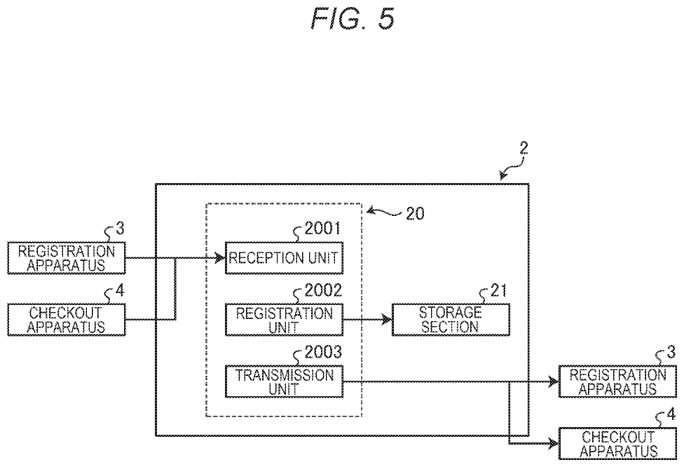

Next, a functional configuration of the controller 20 of the store server 2 is described. FIG. 5 is a block diagram illustrating functional aspects of the controller 20 of the store server 2. The controller 20 functions as a reception unit 2001, a registration unit 2002, and a transmission unit 2003 by the CPU 201 operating in accordance with the control program stored in the ROM 202 and the storage section 21. Note that each of the functions may be configured by hardware such as a dedicated circuit.

The reception unit 2001 receives various information from the registration apparatus 3 and the checkout apparatus 4. For example, the reception unit 2001 receives, from the registration apparatus 3, the merchandise code of the merchandise to be purchased by the customer, and the forwarding instruction. Moreover, the reception unit 2001 receives the payment completion notification from the checkout apparatus 4.

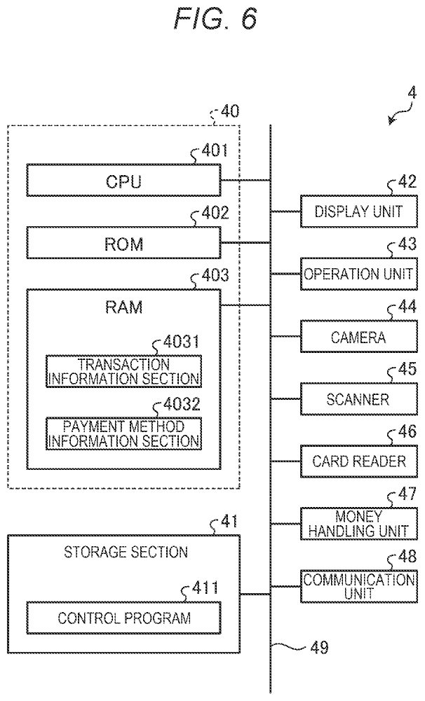

The reception unit 2001 receives a payment method inquiry from the checkout apparatus 4. The payment method inquiry is an inquiry about the payment method registered in advance by the customer, in other words, about the payment method information registered to the customer information file 213. The payment method inquiry includes data indicating the facial feature data of the customer (hereinafter, may also simply be referred to as the “facial feature data”). The facial feature data is data extracted from the facial image data of the customer. The facial image data is captured by a camera 44 (see FIG. 6) provided to the checkout apparatus 4. Note that the reception unit 2001 may 2001 may receive the customer's facial image data captured by the camera 44, and in this case, the controller 20 of the store server 2 extracts the feature data. Moreover, the reception unit 2001 may 2001 may receive the user ID of the customer, instead of the facial feature data.

The reception unit 2001 receives a payment method registration request from the checkout apparatus 4. The payment method registration request is request for registration or update of information in the customer information file 213. The payment method registration request includes the facial feature data and the payment method information which are the information to be registered to the customer information file 213.

The registration unit 2002 registers various data to the storage section 21. For example, the registration unit 2002 executes the merchandise registration to register the merchandise information. The registration unit 2002 reads from the merchandise master data 212 the merchandise information corresponding to the merchandise code received by the reception unit 2001, and registers the read merchandise information to the transaction information file 214.

The registration unit 2002 registers, to the customer information file 213, the facial feature data and the payment method information included in the payment method registration request, in response to the payment method registration request received from the checkout apparatus 4 by the reception unit 2001. When the registration unit 2002 registers new customer information to the customer information file 213, the registration unit 2002 issues the user ID and registers the facial feature data and the payment method information to be associated with the user ID. Moreover, when the registration unit 2002 changes the registered data in response to the registration request, the registration unit 2002 rewrites the payment method information corresponding to the user ID or the facial feature data included in the payment method registration request, to the payment method information included in the payment method registration request.

The transmission unit 2003 transmits various information to the registration apparatus 3 and the checkout apparatus 4. For example, the transmission unit 2003 transmits, to the registration apparatus 3, the merchandise information registered through the merchandise registration. The registration apparatus 3 displays the received merchandise information on a display unit for an operator (store clerk) or a display unit for a customer. The transmission unit 2003 also transmits, to the registration apparatus 3, the transaction ID issued by the controller 20.

The transmission unit 2003 transmits, to the checkout apparatus 4, the transaction information in accordance with the forwarding instruction received by the reception unit 2001. The transaction information transmitted to the checkout apparatus 4 is the transaction information stored in the transaction information file 214 and concerning the transaction ID included in the forwarding instruction. As a response to the payment method inquiry received by the reception unit 2001, the transmission unit 2003 transmits the payment method information to the checkout apparatus 4. The payment method information transmitted to the checkout apparatus 4 is the payment method information stored in the customer information file 213 and corresponding to the facial feature data included in the payment method inquiry.

Next, the checkout apparatus 4 is described. The checkout apparatus 4 acquires the transaction information from the store serve 2, and carries out the checkout processing concerning the transaction information. FIG. 6 is a block diagram illustrating a substantial hardware configuration of the checkout apparatus 4.

The checkout apparatus 4 includes a controller 40, a storage section 41, a display unit 42, an operation unit 43, the camera 44, a scanner 45, a card reader 46, a money handling unit 47, and a communication unit 48. The controller 40, the storage section 41, the display unit 42, the operation unit 43, the camera 44, the scanner 45, the card reader 46, the money handling unit 47, and the communication unit 48 are communicably connected to each other via a bus 49 and the like.

The controller 40 includes a CPU 401, a ROM 402, and a RAM 403. The CPU 401, the ROM 402, and the RAM 403 are connected to each other via the bus 49.

The CPU 401 controls the entire operation of the checkout apparatus 4. The ROM 402 stores various programs (e.g., a program used for activation of the CPU 401) and various data. The RAM 403 is used as a work area of the CPU 401, and loads various programs and various data stored in the ROM 402 and the storage section 41. The controller 40 executes various operations/functions of the checkout apparatus 4 by the CPU 401 operating in accordance with a control program stored in the ROM 402 and the storage section 41 and loaded into the RAM 403.

The RAM 403 includes a transaction information section 4031 and a payment method information section 4032. The transaction information section 4031 stores the transaction information acquired from the store server 2. The payment method information section 4032 stores the payment method information acquired from the store server 2. The transaction information stored in the transaction information section 4031 and the payment method information stored in the payment method information section 4032 are cleared when the corresponding checkout processing is completed.

The storage section 41 includes a storage medium such as an HDD and a flash memory, and retains the stored content even after power is removed. The storage section 41 stores a control program 411.

The control program 411 is, for example, a program to implement functions to acquire the transaction information from the store server 2, functions to accept input of the customer identifying information of the customer, functions to acquire from the store server 2 the payment method information corresponding to the customer identifying information, and functions to execute the payment processing based on the acquired transaction information and the payment method information.

The display unit 42 includes, for example, a liquid crystal panel, and displays various information. For example, the display unit 42 displays the transaction information acquired from the store server 2. The display unit 42 also displays, for example, various screens which guide the customer in the operation of the checkout apparatus 4.

The operation unit 43 is operated to input information into the controller 40 and includes a touch panel provided to a surface of the display unit 42, or the like. The operation unit 43 is operated by the customer. For example, the operation unit 43 is operated to input a shortened-payment instruction instructing to execute payment by the payment method registered in advance by the customer.

The camera 44 captures a facial image of the customer who uses the checkout apparatus 4. For example, when a motion sensor detects a person in front of the display unit 42 where the touch panel (operation unit 43) is provided, the camera 44 starts capturing the image. Although the installation position of the camera 44 is not particularly limited, the camera 44 is desirably installed at a position where the camera 44 can capture the facial image of the customer in front of the operation unit 43. In this embodiment, the camera 44 is installed near the display unit 42.

The scanner 45 reads, from a two-dimensional code displayed on a smartphone of the customer, or the like, a payment ID necessary for the code payment. The scanner 45 also reads the membership number from the membership card of the customer.

The card reader 46 reads, from a credit card of the customer, credit-card information necessary for the credit-card payment. The card reader 46 may be a magnetic card reader, which reads information from a magnetic card, or an IC card reader, which reads information from a card including an IC chip built therein.

The money handling unit 47 accepts bills and coins paid by the customer and dispenses change as necessary when the customer pays by cash payment.

The communication unit 48 is an interface to communicate with the external apparatus such as the store server 2. The controller 40 is connected to the external apparatus via the communication unit 48, and therefore, the controller 40 can transmit and receive information (data) to and from the external apparatus.

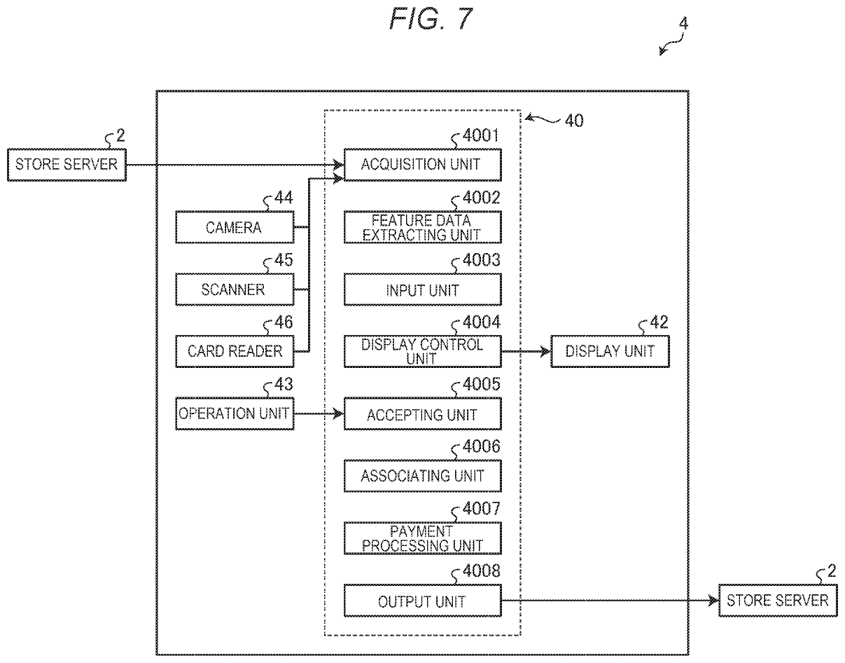

Next, a functional configuration of the controller 40 of the checkout apparatus 4 is described. FIG. 7 is a block diagram illustrating functional aspects of the controller 40 of the checkout apparatus 4. The controller 40 functions as an acquisition unit 4001, a feature data extracting unit 4002, an input unit 4003, a display control unit 4004, an accepting unit 4005, an associating unit 4006, a payment processing unit 4007, and an output unit 4008 by the CPU 401 operating in accordance with the control program stored in the ROM 402 and the storage section 41. Note that each of the functions may be implemented, in whole or in part, by hardware such as a dedicated circuit.

The acquisition unit 4001 acquires various information from the store server 2. For example, the acquisition unit 4001 acquires the transaction information indicating the content of the transaction. The acquisition unit 4001 functions as a first acquisition unit which acquires the transaction information.

The acquisition unit 4001 also acquires the payment method information indicating the payment method. In detail, the acquisition unit 4001 acquires the payment method information from the store server 2 in response to the payment method inquiry from the output unit 4008. The acquisition unit 4001 functions as a second acquisition unit which acquires the payment method information.

The acquisition unit 4001 acquires various information also from the camera 44, the scanner 45, and the card reader 46. For example, the acquisition unit 4001 acquires the captured facial image data of the customer from the camera 44. The acquisition unit 4001 can also acquire, from the scanner 45, the payment ID necessary for the code payment. Furthermore, the acquisition unit 4001 can also acquire the credit-card information from the card reader 46.

The feature data extracting unit 4002 extracts, from the captured facial image data of the customer, the feature data which identifies the person. The feature data extracting unit 4002 uses a facial recognition technique to extract the facial feature data from the captured facial image data for identifying the customer.

The input unit 4003 accepts input of the customer identifying information for the customer who makes the transaction. The input unit 4003 accepts input of the facial feature data extracted from the captured image data by the feature data extracting unit 4002. The facial feature data inputted into the input unit 4003 is the customer identifying information which identifies the customer in the captured image data. The input unit 4003 may also or instead accept input of a user ID or the like as the customer identifying information.

The display control unit 4004 causes the display unit 42 to display various information. For example, the display control unit 4004 causes the display unit 42 to display a selection screen on which a payment method different from the payment method associated with the customer identifying information is selectable. The display control unit 4004 causes the display unit 42 to display an operation element operated to cancel the payment processing in the payment method acquired by the acquisition unit 4001. The screen displayed on the display unit 42 in accordance with the control by the display control unit 4004.

The accepting unit 4005 accepts various input information from the operation unit 43. For example, the accepting unit 4005 accepts the payment method information which indicates the payment method selected through the operation by the customer. In detail, when the customer wishes to register a payment method to be associated with the customer's identifying information, the accepting unit 4005 accepts such payment method information as inputted by the operation of the operation unit 43.

The associating unit 4006 associates the payment method information with the customer identifying information inputted into the input unit 4003. In detail, the associating unit 4006 generates a payment method registration request while associating the payment method information accepted by the accepting unit 4005 with the facial feature data inputted into the input unit 4003.

The payment processing unit 4007 executes the payment processing concerning the transaction information acquired by the acquisition unit 4001. For example, the payment processing unit 4007 executes the transaction payment processing using the payment method acquired by the acquisition unit 4001 from the store server 2. In a cash payment, the payment processing executed by the payment processing unit 4007 includes detecting the amount of received money, calculating the change, dispensing the calculated change, and the like. In the credit-card payment and the code payment, the payment processing executed by the payment processing unit 4007 includes, for example, transmitting and receiving information to and from a settlement server of a settlement service provider.

The output unit 4008 sends various information to the store server 2. For example, when the payment processing unit 4007 completes the payment processing, the output unit 4008 transmits the payment completion notification to the store server 2. The output unit 4008 also transmits the registration request generated by the associating unit 4006 to the store server 2.

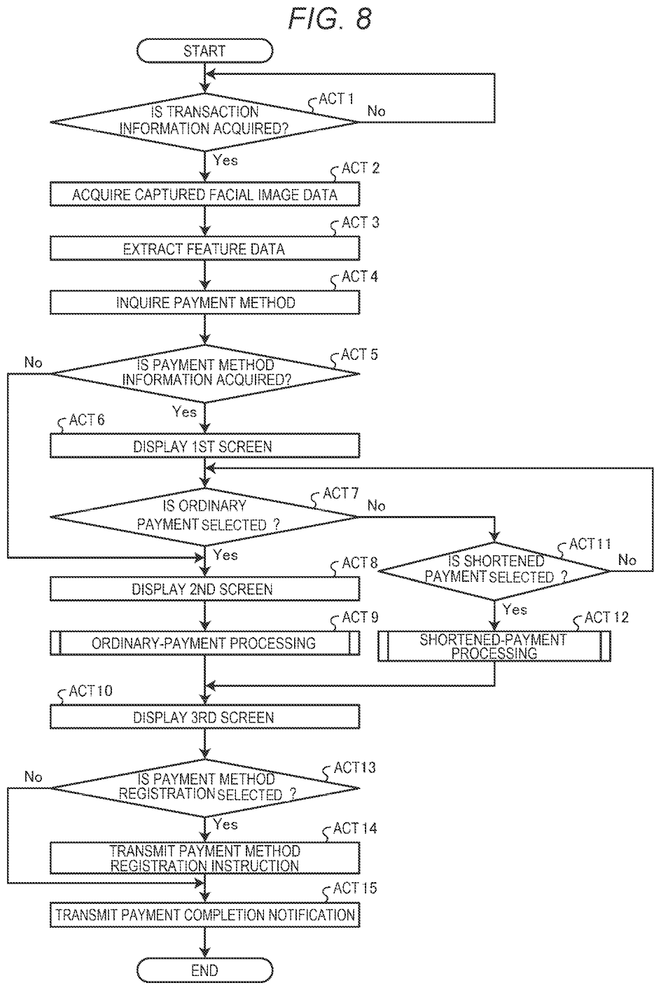

Next, the checkout processing executed by the checkout apparatus 4 is described. FIG. 8 is a flowchart illustrating checkout processing by the controller 40 of the checkout apparatus 4.

The controller 40 determines whether the acquisition unit 4001 has acquired transaction information from the store server 2 (ACT 1). If the acquisition unit 4001 does not acquire the transaction information (ACT 1: No), the controller 40 returns to ACT 1 and stands by. If the acquisition unit 4001 acquires the transaction information (ACT 1: Yes), the acquisition unit 4001 acquires captured facial image data of the customer from the camera 44 (ACT 2). At this time, the acquisition unit 4001 registers the transaction information acquired from the store server 2 to the transaction information section 4031.

The feature data extracting unit 4002 extracts the feature data from the captured facial image data acquired by the acquisition unit 4001 (ACT 3). The output unit 4008 transmits, to the store sever 2, the payment method inquiry which is information including the feature data extracted by the feature data extracting unit 4002 (ACT 4).

The controller 40 determines whether the acquisition unit 4001 has acquired payment method information from the store server 2 (ACT 5). If the acquisition unit 4001 acquires the payment method information from the store server 2 (ACT 5: Yes), the display control unit 4004 causes the display unit 42 to display a first screen (ACT 6). At this time, the acquisition unit 4001 registers the payment method information acquired from the store server 2 to the payment method information section 4032.

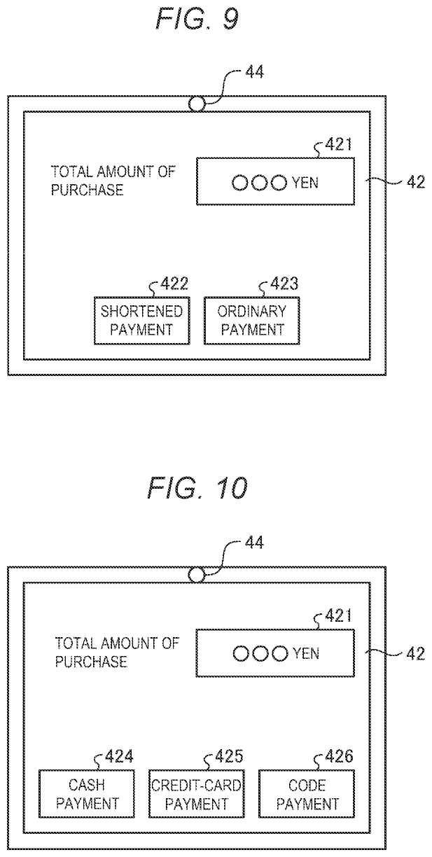

FIG. 9 is a diagram illustrating the first screen displayed by the display unit 42 of the checkout apparatus 4. The first screen shows a transaction amount display field 421, a shortened-payment button 422, and an ordinary-payment button 423. The camera 44 is near the upper side edge of the display unit 42. Note that, for any screen described hereinafter, the same reference numerals are given to aspects substantially similar to those of the first screen and redundant description thereof may be omitted.

The transaction amount display field 421 shows the transaction amount included in the transaction information acquired by the acquisition unit 4001. The shortened-payment button 422 is an operation element to select a shortened payment (e.g., a quick payment process). The shortened payment in this context is payment by a method registered in advance. The ordinary-payment button 423 is an operation element to select an ordinary payment (standard payment process). The ordinary payment is payment without using a payment method registered in advance. Even a customer who registers a payment method in advance can select the ordinary payment process. Therefore, for example, when the registered payment method of the customer is an expired or now-invalid credit card or the like, the customer can select another payment method at this point. The first screen is one example of the selection screen on which a payment method different from the payment method associated with the customer identifying information is selectable.

Returning back to the flowchart in FIG. 8, the checkout processing is described. The controller 20 determines whether the accepting unit 4005 has received the ordinary payment selection (ACT 7). In other words, the controller 20 determines whether the ordinary-payment button 423 is operated on the first screen. If the accepting unit 4005 accepts the ordinary payment (ACT 7: Yes), the display control unit 4004 causes the display unit 42 to display a second screen (ACT 8).

Note that, in ACT 5, if the acquisition unit 4001 does not acquire the payment method information from the store server 2 (ACT 5: No), the controller 20 omits ACT 6 and ACT 7, and proceeds to ACT 8. In other words, if the payment method of the customer who pays is not registered in advance, the display control unit 4004 causes the display unit 42 to display the second screen without displaying the first screen.

FIG. 10 is a diagram illustrating the second screen displayed by the display unit 42 of the checkout apparatus 4. The second screen shows the transaction amount display field 421, a cash payment button 424, a credit-card payment button 425, and a code payment button 426.

The cash payment button 424 is an operation element to select cash payment. The credit-card payment button 425 is an operation element to select credit-card payment. The code payment button 426 is an operation element to select code payment. Note that if the checkout apparatus 4 is capable of accepting payment by another payment method, the second screen also shows an operation element to select the other payment method.

Returning back to the flowchart in FIG. 8, the checkout processing is described. The payment processing unit 4007 executes an ordinary-payment processing based on the operation of the second screen by the customer (ACT 9). When the ordinary-payment processing is completed, the display control unit 4004 causes the display unit 42 to display a third screen (ACT 10).

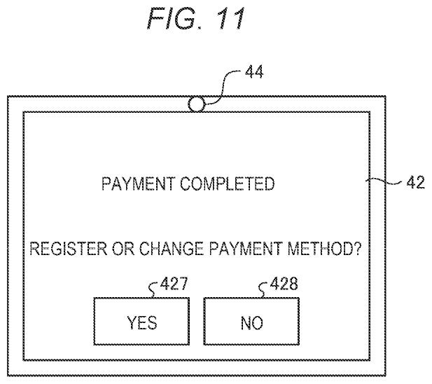

FIG. 11 is a diagram illustrating the third screen displayed by the display unit 42 of the checkout apparatus 4. The third screen shows information indicating completion of the payment. The third screen shows information asking about registration of the payment method or changing of the registered payment method along with an YES button 427 and a NO button 428.

The YES button 427 is an operation element to select to register the payment method or to change the registered payment method. The NO button 428 is an operation element to select not to register the payment method or not to change the registered payment method. The customer can register the payment method or change the registered payment method by selecting the YES button 427.

Returning back to the flowchart in FIG. 8, the checkout processing is described. In ACT 7, if the accepting unit 4005 does not accept the ordinary payment (ACT 7: No), the controller 20 determines whether the accepting unit 4005 accepts the shortened payment (ACT 11). If the accepting unit 4005 does not accept the shortened payment (ACT 11: No), the controller 20 returns to ACT 7.

If the accepting unit 4005 accepts the shortened payment (ACT 11: Yes), the payment processing unit 4007 executes a shortened-payment processing (ACT 12). The controller 20 proceeds to ACT 10 when the shortened-payment processing is completed.

The controller 20 determines whether the accepting unit 4005 accepts the payment method registration (ACT 13). If the accepting unit 4005 accepts the payment method registration (ACT 13: Yes), in other words, the YES button 427 is operated on the third screen, the output unit 4008 transmits a payment method registration instruction to the store server 2 (ACT 14).

When the store server 2 receives the payment method registration instruction, the store server 2 executes processing concerning the registration of the payment method or the changing of the registered payment method. A method of the processing concerning the registration of the payment method or the changing of the registered payment method is not particularly limited, but may be any method.

Then, the output unit 4008 transmits to the store server 2 the payment completion notification (ACT 15). Then, the controller 20 ends the checkout processing. Note that, in ACT 13, if the accepting unit 4005 does not accept the payment method registration (ACT 13: No), in other words, if the NO button 428 is operated on the third screen, the controller 20 omits ACT 14, and proceeds to ACT 15.

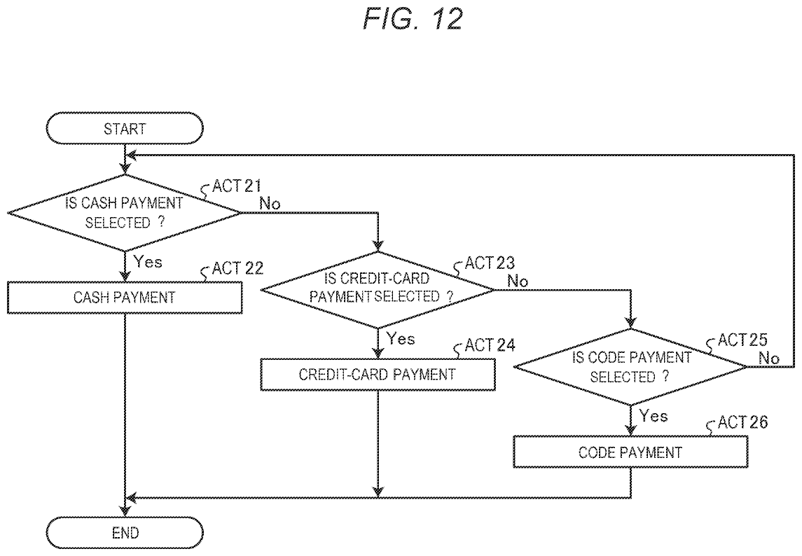

Next, the ordinary-payment processing is described. FIG. 12 is a flowchart illustrating ordinary-payment processing by the controller 40 of the checkout apparatus 4.

The payment processing unit 4007 determines whether the accepting unit 4005 accepts the cash payment (ACT 21). In other words, the payment processing unit 4007 determines whether the cash payment button 424 is operated on the second screen. If the accepting unit 4005 accepts the cash payment (ACT 21: Yes), the payment processing unit 4007 executes the cash payment (ACT 22), and ends the ordinary-payment processing.

If the accepting unit 4005 does not accept the cash payment (ACT 21: No), the payment processing unit 4007 determines whether the accepting unit 4005 accepts the credit-card payment (ACT 23). In other words, the payment processing unit 4007 determines whether the credit-card payment button 425 is operated on the second screen. If the accepting unit 4005 accepts the credit-card payment (ACT 23: Yes), the payment processing unit 4007 executes the credit-card payment (ACT 24), and ends the ordinary-payment processing.

If the accepting unit 4005 does not accept the credit-card payment (ACT 23: No), the payment processing unit 4007 determines whether the accepting unit 4005 accepts the code payment (ACT 25). In other words, the payment processing unit 4007 determines whether the code payment button 426 is operated on the second screen. If the accepting unit 4005 accepts the code payment (ACT 25: Yes), the payment processing unit 4007 executes the code payment (ACT 26), and ends the ordinary-payment processing. If the accepting unit 4005 does not accept the code payment (ACT 25: No), the payment processing unit 4007 returns to ACT 21.

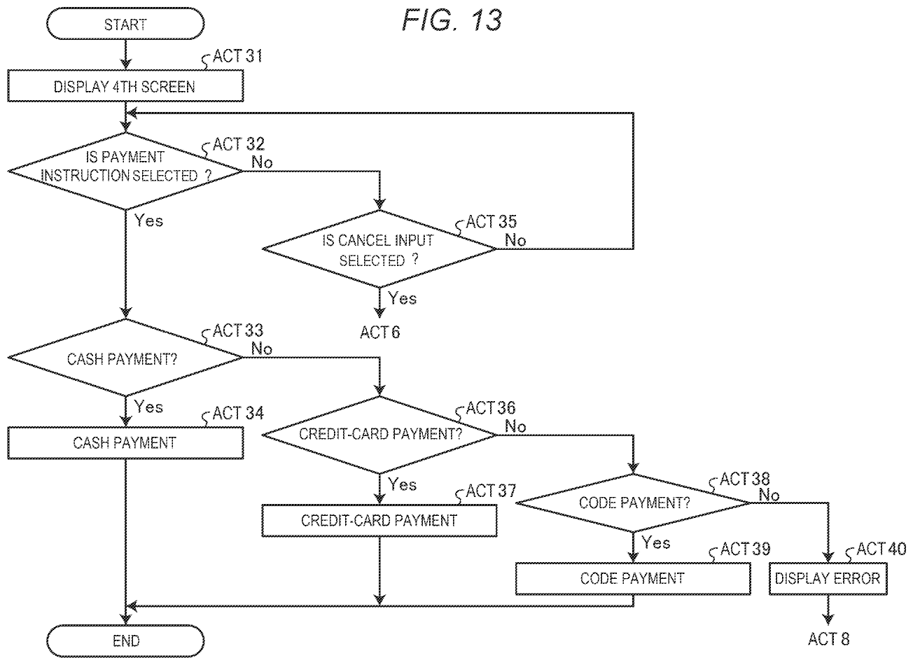

Next, the shortened-payment processing is described. FIG. 13 is a flowchart illustrating shortened-payment processing by the controller 40 of the checkout apparatus 4.

In the shortened-payment processing, first, the display control unit 4004 causes the display unit 42 to display a fourth screen (ACT 31.)

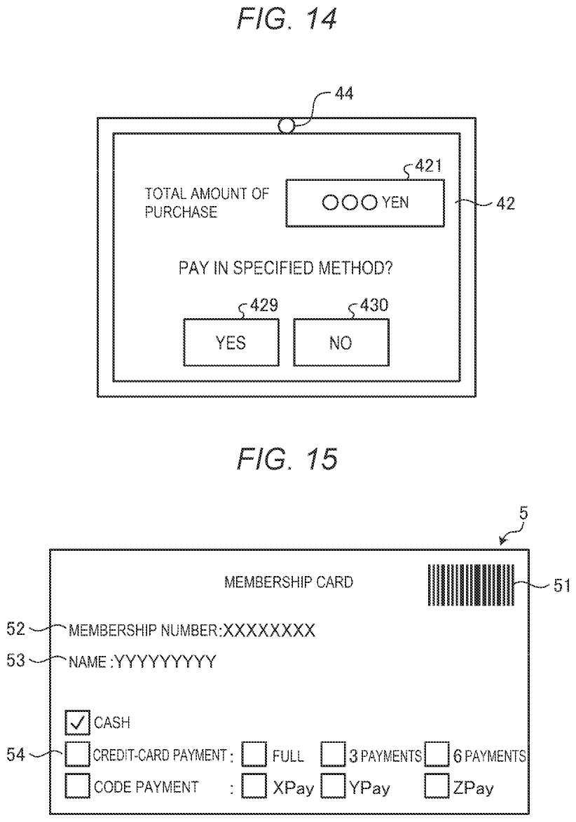

FIG. 14 is a diagram illustrating the fourth screen displayed by the display unit 42 of the checkout apparatus 4. The fourth screen shows the transaction amount display field 421, and a confirmation button (an YES button 429 and a NO button 430).

The YES button 429 is an operation element to confirm the payment in the registered payment method. The NO button 430 is an operation element to cancel the payment in the registered payment method. The NO button 430 is one example of an operation element to cancel the payment processing using the payment method indicated by the payment method information acquired by the acquisition unit 4001.

Returning back to the flowchart in FIG. 13, the shortened-payment processing is described. The payment processing unit 4007 determines whether the accepting unit 4005 accepts a payment instruction (ACT 32). In other words, the payment processing unit 4007 determines whether the YES button 429 is operated on the fourth screen.

If the accepting unit 4005 accepts the payment instruction (ACT 32: Yes), the payment processing unit 4007 determines whether the payment method information stored in the payment method information section 4032 indicates the cash payment (ACT 33). In other words, the payment processing unit 4007 determines whether the payment method acquired from the store server 2 is cash payment.

If the payment method information stored in the payment method information section 4032 indicates cash payment (ACT 33: Yes), the payment processing unit 4007 executes the cash payment (ACT 34), and ends the shortened-payment processing.

In ACT 32, if the accepting unit 4005 does not accept the payment instruction (ACT 32: No), the payment processing unit 4007 determines whether the accepting unit 4005 accepts a cancelling input (ACT 35). If the accepting unit 4005 does not accept the cancelling input (ACT 35: No), the payment processing unit 4007 returns to ACT 32. If the accepting unit 4005 accepts the cancelling input (ACT 35: Yes), the controller 40 proceeds to ACT 6 (see FIG. 8).

In ACT 33, if the payment method information stored in the payment method information section 4032 does not indicate cash payment (ACT 33: No), the payment processing unit 4007 determines whether the payment method information stored in the payment method information section 4032 indicates the credit-card payment (ACT 36). In other words, the payment processing unit 4007 determines whether the payment method acquired from the store server 2 is credit-card payment.

If the payment method information stored in the payment method information section 4032 indicates credit-card payment (ACT 36: Yes), the payment processing unit 4007 executes the credit-card payment (ACT 37), and ends the shortened-payment processing.

If the payment method information stored in the payment method information section 4032 does not indicate credit-card payment (ACT 36: No), the payment processing unit 4007 determines whether the payment method information stored in the payment method information section 4032 indicates code payment (ACT 38). In other words, the payment processing unit 4007 determines whether the payment method acquired from the store server 2 is code payment.

If the payment method information stored in the payment method information section 4032 indicates code payment (ACT 38: Yes), the payment processing unit 4007 executes code payment (ACT 39), and ends the shortened-payment processing.

If the payment method information stored in the payment method information section 4032 does not indicate code payment (ACT 38: No), the display control unit 4004 causes the display unit 42 to display error information (ACT 40). The error information is information indicating that a payment method is not registered. That is, if the shortened payment is selected even though the customer did not register a payment method in advance, the display control unit 4004 causes the display unit 42 to display the error information. When a given period of time passes after the error information is displayed, the controller 40 proceeds to ACT 8 (see FIG. 8).

As described above, the checkout apparatus 4 according to Embodiment 1 includes the first acquisition unit (acquisition unit 4001), the input unit 4003, the second acquisition unit (acquisition unit 4001), and the payment processing unit 4007. The first acquisition unit (acquisition unit 4001) acquires the transaction information indicating the content of the transaction. The input unit 4003 accepts the input of the customer identifying information (facial feature data) that identifies the customer who makes the transaction. The second acquisition unit (acquisition unit 4001) acquires the payment method information indicating the payment method associated with the customer identifying information inputted into the input unit 4003. The payment processing unit 4007 executes the payment processing related to the transaction information acquired by the first acquisition unit using the payment method indicated by the payment method information acquired by the second acquisition unit.

Therefore, the customer can pay using the payment method registered in advance. However, the customer can freely set the payment method that is registered in advance. Thus, the checkout apparatus 4 is capable of improving operability while securing freedom for the customer to select the payment method.

The checkout apparatus 4 according to Embodiment 1 further includes the display control unit 4004 which causes the display unit 42 to display the selection screen (first screen) on which the payment method different from the payment method associated with the customer identifying information is selectable. Furthermore, the display control unit 4004 causes the display unit 42 to display the operation element (NO button 430) which is operated to cancel the payment processing using the payment method indicated by the payment method information acquired by the second acquisition unit (acquisition unit 4001).

Therefore, before or after the operator of the checkout apparatus 4 selects payment by the payment method registered in advance, the operator can pay using a method different from the method that was registered in advance. In this respect, the checkout apparatus 4 is capable of further improving the operability.

In addition, the checkout apparatus 4 according to Embodiment 1 further includes the accepting unit 4005 and the associating unit 4006. The accepting unit 4005 accepts the payment method information indicating the payment method selected through the operation by the operator. The associating unit 4006 associates the payment method information accepted by the accepting unit 4005 with the customer identifying information inputted into the input unit 4003.

Therefore, the payment method of the customer can be registered through the operation of the checkout apparatus 4. Therefore, the customer can register a payment method when paying for a purchase. Thus, the checkout apparatus 4 is capable of improving customer convenience.

### Embodiment 2

Next, Embodiment 2 is described. The checkout apparatus 4 according to Embodiment 2 reads the payment method from a medium held by the customer, and carries out the payment processing according to the payment method that is read. Below, description of aspects similar to those of Embodiment 1 may be omitted in order to avoid unnecessarily redundant description, and to facilitate understanding of Embodiment 2.

FIG. 15 is a diagram illustrating a membership card of a customer. The membership card 5 includes a barcode 51, a membership number 52, a name 53, and a payment method selection field 54. The membership card 5 is one example of a medium indicating the payment method. Note that the medium is not limited to a membership card as long as the medium is capable of indicating a payment method.

The barcode 51 is where information about the member is encoded. The membership number 52 is a number to identify the member. The name 53 is a name of the member. The payment method selection field 54 is a field where a check mark is placed to select the payment method. In the example in FIG. 15, the member who owns the membership card selects the cash payment.

Note that if credit-card payment is selected, the associated additional information (credit card number, payment installments) may also be selected. If code payment is selected, the type of code payment may also be selected. For example, if credit-card payment is selected but no option for the number of installment payments is selected, the checkout apparatus 4 may 4 may display an error indication. Similarly, if code payment is selected but no type of code payment option is selected, the checkout apparatus 4 may display an error indication.

When the checkout apparatus 4 reads the payment method from the membership card during the checkout processing, the checkout apparatus 4 carries out the payment processing in the read payment method. For example, the checkout apparatus 4 reads, from image data of the membership card captured by the camera 44, the payment method using image processing technique. The controller 40 of the checkout apparatus 4 is provided with a reading unit which reads the payment method from the image data of the membership card captured by the camera 44.

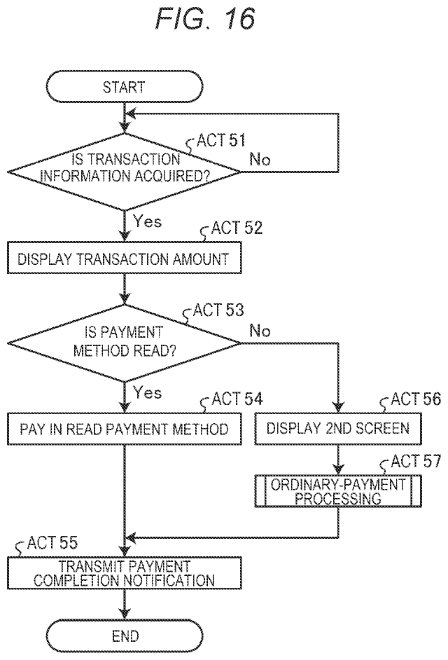

Next, the checkout processing executed by the checkout apparatus 4 is described. FIG. 16 is a flowchart illustrating checkout processing by the controller 40 of the checkout apparatus 4.

The controller 40 determines whether the acquisition unit 4001 has acquired the transaction information (ACT 51). If the acquisition unit 4001 does not acquire the transaction information (ACT 51: No), the controller 40 returns to ACT 51 and stands by. If the acquisition unit 4001 acquires the transaction information (ACT 51: Yes), the display control unit 4004 causes the display unit 42 to display the transaction amount (ACT 52). At this time, if the payment method is to be read from the membership card, the display control unit 4004 causes the display unit 42 to display an instruction message to place the membership card in front of the camera 44.

Then, the controller 40 determines whether the reading unit reads the payment method within a given period of time (ACT 53). If the reading unit reads the payment method in the given period of time (ACT 53: Yes), the payment processing unit 4007 executes the payment using the payment method read by the reading unit (ACT 54). Then, the output unit 4008 transmits the payment completion notification to the store server 2 (ACT 55). Then, the controller 40 ends the checkout processing.

In ACT 53, if the reading unit does not read the payment method in the given period of time (ACT 53: No), the display control unit 4004 causes the display unit 42 to display the second screen (ACT 56). Then, the payment processing unit 4007 executes the ordinary-payment processing (ACT 57). The ordinary-payment processing in this context can be similar to that of Embodiment 1. Then, the controller 40 proceeds to ACT 55.

The checkout apparatus 4 according to Embodiment 2 includes the first acquisition unit (acquisition unit 4001), the reading unit, and the payment processing unit 4007. The first acquisition unit (acquisition unit 4001) acquires the transaction information indicating the content of the transaction. The reading unit reads the payment method from the medium owned by the customer who makes the transaction. The payment processing unit 4007 executes the payment processing related to the transaction information acquired by the first acquisition unit using the payment method read by the reading unit.

Therefore, the customer can pay using the payment method which is indicated in the medium in advance. The customer may also freely select the payment method to be indicated in the medium. Thus, the checkout apparatus 4 is capable of improving operability while still securing freedom for the customer to select the payment method.

Note that in the embodiments described above the control programs executed in the store server 2 and the checkout apparatus 4 may be recorded in a non-transitory, computer-readable recording medium such as a CD-ROM. The control programs described above may be stored on a computer connected to a network such as the Internet and downloaded via the network, or may be otherwise be provided, accessed, or distributed via a network such as the Internet.

While certain embodiments are described above, these embodiments are presented as examples, and not intended to limit the scope of the disclosure. These embodiments can be embodied in a variety of other forms, and various omissions, replacements, and changes can be applied to the embodiments without departing from the spirit of the disclosure. The embodiments and modifications are covered by the appended claims and their equivalents as well as being included in the scope and spirit of the disclosure.

What is claimed is:

1. A checkout apparatus, comprising:
a communication interface connectable to a network;
a display unit positioned to face a customer at the checkout apparatus;
an input unit configured to receive user inputs from the customer; and
a control unit configured to:
acquire transaction information for a transaction of the customer via the communication interface;
receive customer identifying information identifying the customer;
acquire payment method information indicating a payment method associated with the customer identifying information; and
execute payment processing for the transaction based on the acquired transaction information using the payment method associated with the customer.

2. The checkout apparatus according to claim 1, wherein the control unit is further configured to:
cause the display unit to display a selection screen on which a payment method different from the payment method associated with the customer identifying information is selectable by the customer.

3. The checkout apparatus according to claim 2, wherein the control unit is further configured to:
execute the payment processing for the transaction based on the acquired transaction using the payment method different from the payment method associated with the customer identifying information.

4. The checkout apparatus according to claim 2, wherein the control unit is further configured to:
cause the display unit to display cancellation button which when selected cancels the payment processing using the payment method associated with the customer identifying information.

5. The checkout apparatus according to claim 1, wherein the control unit is further configured to:
receive a payment method selection via the input unit and a request to associate the payment method selection with the customer identifying information.

6. The checkout apparatus according to claim 1, wherein the transaction information is acquired from a store server.

7. The checkout apparatus according to claim 1, further comprising:
a camera positioned to acquire an image of the face of the customer, wherein
the customer identifying information is facial image data corresponding to the acquired image.

8. The checkout apparatus according to claim 1, further comprising:
a camera positioned to acquire an image of a membership card of the customer, wherein
the customer identifying information is read from the membership card.

9. The checkout apparatus according to claim 8, wherein the payment method information indicating the payment method associated with the customer identifying information is acquired from the image of the membership card.

10. A checkout system, comprising:
a store server connected to a network;
a registration apparatus connected the network and configured to generate transaction information for a transaction of a customer; and
a checkout apparatus including:
a communication interface connected to the network;
a display unit positioned to face the customer at the checkout apparatus;
an input unit configured to receive user inputs from the customer; and
a control unit configured to:
acquire transaction information for a transaction of the customer via the communication interface;
receive customer identifying information identifying the customer;
acquire payment method information indicating a payment method associated with the customer identifying information; and
execute payment processing for the transaction based on the acquired transaction information using the payment method associated with the customer.

11. The checkout system according to claim 10, wherein the control unit is further configured to:
cause the display unit to display a selection screen on which a payment method different from the payment method associated with the customer identifying information is selectable by the customer.

12. The checkout system according to claim 11, wherein the control unit is further configured to:
execute the payment processing for the transaction based on the acquired transaction using the payment method different from the payment method associated with the customer identifying information.

13. The checkout system according to claim 10, further comprising:
a camera positioned to acquire an image of the face of the customer, wherein
the customer identifying information is facial image data corresponding to the acquired image.

14. The checkout system according to claim 10, further comprising:
a camera positioned to acquire an image of a membership card of the customer, wherein
the customer identifying information is read from the membership card.

15. The checkout system according to claim 14, wherein the payment method information indicating the payment method associated with the customer identifying information is acquired from the image of the membership card.

16. A checkout method for executing payment processing for a transaction, the method comprising:
acquiring transaction information for a transaction of a customer via a communication interface;
receiving customer identifying information identifying the customer;
acquiring payment method information indicating a payment method associated with the customer identifying information; and
executing payment processing for the transaction based on the acquired transaction information using the payment method associated with the customer.

17. The checkout method according to claim 16, further comprising:
acquiring an image of the face of the customer, wherein
the customer identifying information is facial image data corresponding to the acquired image.

18. The checkout method according to claim 16, further comprising:
acquiring an image of a membership card of the customer, wherein
the customer identifying information is read from the membership card.

19. The checkout method according to claim 18, wherein the payment method information indicating the payment method associated with the customer identifying information is acquired from the image of the membership card.

20. The checkout method according to claim 19, wherein the payment method information is displayed on the membership card in a plain text.
